(19) United States
(12) Patent Application Publication
(10) Pub. No.: US 2013/0232949 A1
(43) Pub. Date: Sep. 12, 2013

(54) PRESSURE BALANCED AREA CONTROL OF HIGH ASPECT RATIO NOZZLE

(71) Applicant: Gary J. Dillard, Brownsboro, AL (US)

(72) Inventor: Gary J. Dillard, Brownsboro, AL (US)

(21) Appl. No.: 13/416,676

(22) Filed: Mar. 9, 2012

(51) Int. Cl. F02K 1/44; B23P 11/00; F02K 1/40

(52) U.S. Cl. 60/262; 239/265.11; 29/889.22

(57) ABSTRACT

An apparatus for minimizing signature of an engine having an exhaust gas path and a fan gas path includes a casing, and a liner disposed within the casing. The exhaust gas path passes within the liner and the fan gas path passes between the liner and the casing. The casing is disconnected into an upstream portion and a downstream portion, each portion in registration with the liner, such that there are minimum pressure imbalances caused by the exhaust gas path, the fan gas path and ambient on the downstream portion.

### BACKGROUND

The present invention relates to gas turbine engines and, more particularly, to nozzles therefor.

A typical gas turbine engine operates in an extremely harsh environment characterized by very high temperatures and vibrations. A conventional gas turbine engine includes a compressor for compressing entering air, a combustor for mixing and burning the compressed gases that emerge from the compressor with fuel, a turbine for expanding the hot gases to generate thrust to propel the engine, and an exhaust nozzle for allowing hot gases to exit the engine. Thus, the exhaust nozzle must accommodate extremely hot gases exiting the engine.

In military operations, design of planes to avoid detection by radar is an important issue. The ability of the plane to remain undetected depends on the overall geometry of the plane and its engine. To minimize detection, it is preferable to minimize the detectability (i.e., the signature) of the engine.

### SUMMARY

According to an embodiment disclosed herein an apparatus for minimizing signature of an engine having an exhaust gas path and a fan gas path includes a casing, and a liner disposed within the casing. The exhaust gas path passes within the liner and the fan gas path passes between the liner and the casing. The casing is disconnected into an upstream portion and a downstream portion, each portion in registration with the liner, such that there are minimum pressure imbalances caused by the exhaust gas path, the fan gas path and ambient on the downstream portion.

In one example embodiment that includes the elements of the foregoing embodiment, a flexible seal disposed between the upstream portion and the downstream portion.

In another example embodiment that includes the elements of the foregoing embodiment, the casing and the liner comprise an exhaust nozzle.

In another example embodiment that includes the elements of the foregoing embodiment, the casing and the liner further comprise a forward portion and an aft portion wherein a flexible seal is disposed between the casing forward portion and the casing aft portion.

In another example embodiment that includes the elements of the foregoing embodiment, casing and the liner further have a convergent portion disposed between the forward portion and the aft portion.

In another example embodiment that includes the elements of the foregoing embodiment, the flexible seal is disposed within the casing divergent portion.

In another example embodiment that includes the elements of the foregoing embodiment, there are no supports between the upstream segment and the downstream segment.

According to a further embodiment disclosed herein, a nozzle for minimizing signature of a gas turbine engine having an exhaust gas path and a fan gas path, includes a casing and a liner disposed within the casing. The exhaust gas path passes within the liner and the fan gas path passes between the liner and the casing. The casing is disconnected into an upstream portion and a downstream portion, each portion in registration with the liner, such that there are minimum pressure imbalances caused by the exhaust gas path, the fan gas path and ambient on the downstream portion.

In another example embodiment that includes the elements of the foregoing embodiment, a flexible seal disposed between the upstream portion and the downstream portion.

In another example embodiment that includes the elements of the foregoing embodiment, the casing and the liner further comprise a forward portion and an aft portion wherein a flexible seal is disposed between the casing forward portion and the casing aft portion.

In another example embodiment that includes the elements of the foregoing embodiment, the casing and the liner further have a convergent portion disposed between the forward portion and the aft portion.

In another example embodiment that includes the elements of the foregoing embodiment, the flexible seal is disposed within the casing divergent portion.

In another example embodiment that includes the elements of the foregoing embodiment, there are no supports upstream of the flexible seal between the casing and the liner.

In another example embodiment that includes the elements of the foregoing embodiment, there are no supports between the upstream segment and the downstream segment.

According to a further embodiment disclosed herein, a method for designing a nozzle for minimizing signature of a gas turbine engine having an exhaust gas path and a fan gas path, includes the steps of providing a casing, providing a liner disposed within the casing, the exhaust gas path passing within the liner and the fan gas path passing between the liner and the casing, wherein the casing is disconnected into an upstream portion and a downstream portion, each portion in registration with the liner, such that there are minimum pressure imbalances caused by the exhaust gas path, the fan gas path and ambient on the downstream portion.

In another example embodiment that includes the elements of the foregoing embodiment, the method includes providing a flexible seal between the upstream portion and the downstream portion.

In another example embodiment that includes the elements of the foregoing embodiment, determining an inward load on the liner, determining an outward load on the downstream portion, and determining a net of the inward load and the outward load.

In another example embodiment that includes the elements of the foregoing embodiment, the method includes adjusting a length of the downstream portion if the net does not approximate zero.

In another example embodiment that includes the elements of the foregoing embodiment, the method includes adjusting a length of the upstream portion if the net does not approximate zero.

### BRIEF DESCRIPTION OF THE DRAWINGS

These and other features of the present invention can be best understood from the following specification and drawings, the following of which is a brief description.

FIG. 1 is a schematic depiction of a gas turbine engine incorporating an embodiment of a nozzle.

FIG. 2 is a cross-portional schematic depiction of a prior art nozzle portion of an engine.

FIG. 3 is a cross-portional schematic view of a nozzle used in in the gas turbine engine of FIG. 1.

FIG. 4 is a perspective view of the nozzle of FIG. 3.

FIG. 5 is a block diagram of a method for designing the nozzle of FIG. 3.

### DETAILED DESCRIPTION

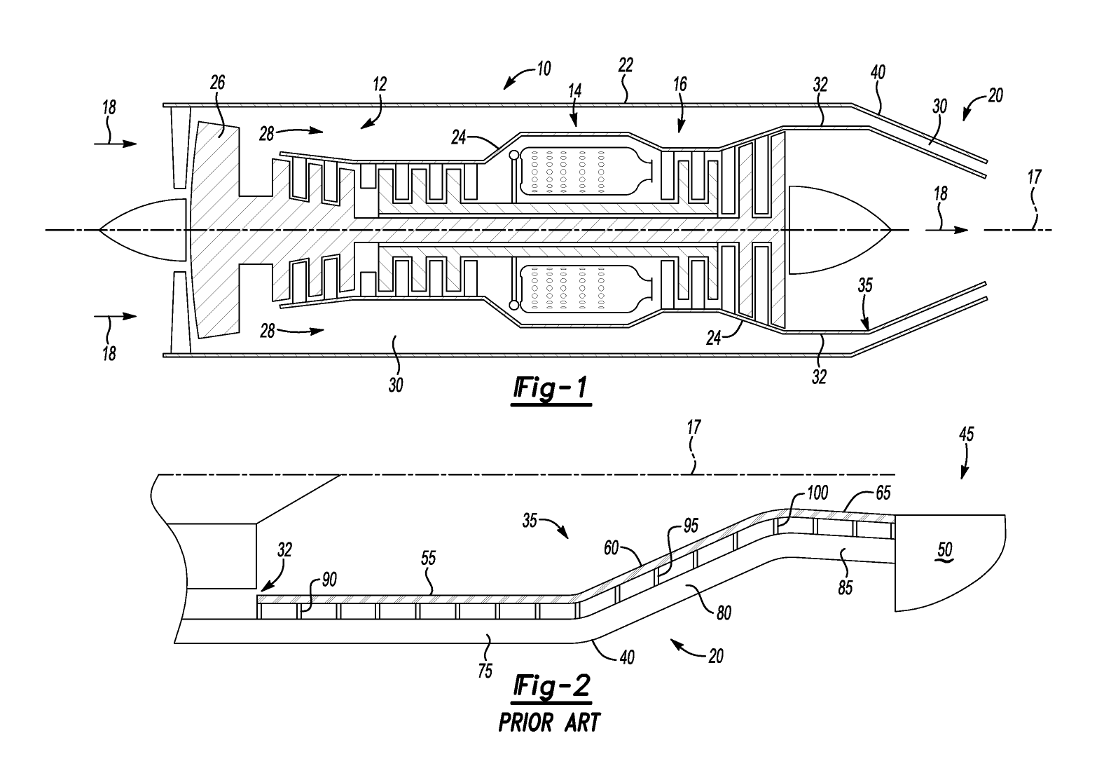

Referring to FIG. 1, a gas turbine engine 10 includes a compressor 12, a combustor 14, and a turbine 16 centered about a central axis 17. A first air flow 18 passes axially through the compressor 12, the combustor 14, and the turbine 16. As is well known in the art, the first air flow 18 is compressed in the compressor 12. Subsequently, the compressed first air flow 18 is mixed with fuel and burned in the combustor 14. The hot gases of the first air flow 18 expand generating thrust to propel the engine 10 and to drive the turbine 16, which in turn drives the compressor 12 and a fan 26. The exhaust gases from the turbine 16 exit through the exhaust nozzle 20. Though a two spool engine 10 is shown herein, one of ordinary skill in the art will recognize that other numbers of spools may be utilized with the teaching provided herein.

The engine 10 has an exterior casing 22 that extends a length of the engine and an interior casing 24 that encloses the compressor 12, the combustor 14 and the turbine 16. The fan 26 drives a second air flow 28 through an area 30 between the exterior casing 22 and the interior casing 24. A gap 32 exists between the interior casing 24 and a nozzle liner 35. The second air flow 28 flows between the nozzle liner 35 and a case 40 of the exterior casing 22.

Referring now to FIG. 2, a prior art version of the exhaust nozzle 20 is shown. The exhaust nozzle 20 includes the nozzle liner 35, the exterior case 40 and, at an aft end thereof 45, a convergence portion 50 that may or may not be mobile. The nozzle liner 35 has a liner forward portion 55, a liner central converging portion 60 and a liner aft portion 65 that is approximately in parallel to the forward portion 55 and disposed radially inwardly thereof. As will be seen infra, this exhaust nozzle 20 flattens so the liner aft portion 65 may vary as to its radial relationship with the liner forward portion 55 about a perimeter of the nozzle 20.

Similarly, the exterior case 40 has a cross-portional shape mimicking the shape of the liner 35. The exterior case 40 has a case forward portion 75, a case converging portion 80 and a case aft portion 85 that is approximately in parallel to the case forward portion 75 and disposed radially inwardly thereof. As will be seen infra, this exhaust nozzle 20 flattens so the case aft portion 85 may vary as to its radial relationship with the case forward portion 75 about a perimeter of the nozzle 20. A plurality of supports 90 extend between the liner forward portion 55 and the case forward portion 75, supports 95 extend between the liner converging portion 60 and the case converging portion 80, and supports 100 extend between the liner aft portion 65 and the liner aft portion 85. The supports 90, 95, 100 act to maintain the nozzle liner 35 and exterior case 40 at a roughly equal distance apart.

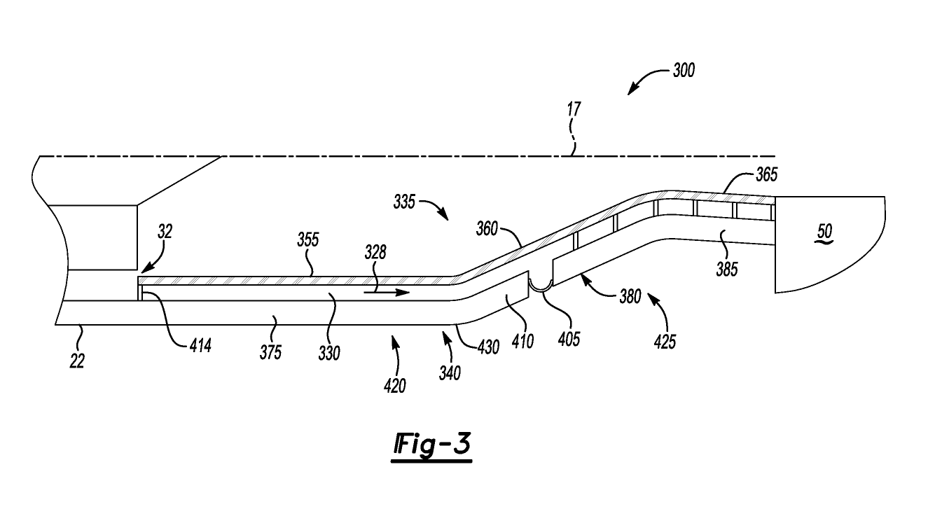

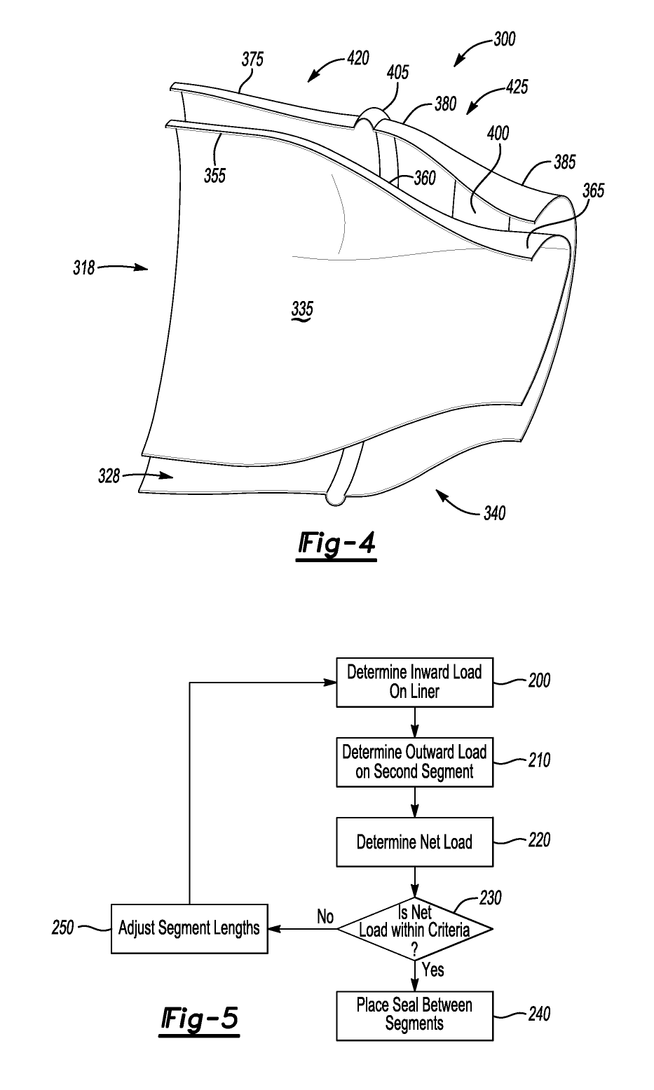

Referring now to FIGS. 3 and 4, an exemplary embodiment is shown. For ease of illustration, the numbering system for FIGS. 2 and 3 are consistent to highlight the differences between the prior art shown in FIG. 2 and the exemplary embodiment shown in FIGS. 3 and 4. There are pressure forces on the inner liner 335 and the case 340 that may affect the signature of the engine 10. For instance, the pressure of the second air flow 328 between the inner liner 335 and the case 340 along the length of the nozzle is generally greater than the pressure of the first air flow 318 along the length of the nozzle 300 and greater than ambient radially outside of the case 340. Also the pressure of the first air flow 318 is greater than ambient radially outside of the case 340. The pressures sum to a net outward load on the system. However, it has been discovered that pressure imbalances on the liner aft portion 365 and the case aft portion 385 (and possibly portions of the case converging portion 380 and a liner converging portion 360) may provide a signature for the engine 10. In order to minimize the effect of the pressure imbalances on the liner aft portion 365 and the case aft portion 385 (and possibly portions of the case converging portion 380 and a liner converging portion 360), it is preferable to shift the pressure imbalances to the case forward portion 375 and to the liner forward portion 355 (and possibly portions of the case converging portion 380 and a liner converging portion 360) as will be discussed infra.

A flexible seal 405, made of an elastomer reinforced fabric or the like, is disposed between attached to an upstream side 410 and a downstream side of the case converging portion 380. The supports 90 that extend between the liner forward portion 55 and the case forward portion 75 in the prior art are removed. A bumper 415 may be disposed between the case forward portion 375 and the liner forward portion to minimize contact between the parts. The supports 395 upstream of the seal 405 on the case converging portion 380 are also removed.

By separating the case 340 into a first segment 420 upstream of the seal 405 and a second segment 425 downstream of the seal, the second segment 425 is free to move without being affected by the expansion of the first segment 420. Given particular geometries of the liner 335 and the case 340; the relative lengths and circumferences; and the particular pressure differences between the liner 335 and the case 340 regarding the first air flow 318, the second air flow 328 and ambient, the pressure imbalances on the second segment 125 tend to equalize such that the net load results in a liner displacement which meets a pre-determined criteria.

FIG. 4 shows that the exhaust nozzle 320 smoothly tends to flatten out through the liner and case forward portions 355, 375, the liner and case converging portions 360, 380 and the liner and case aft portions 360, 380. Because exhaust nozzles may have different shapes and geometries, one of ordinary skill in the art will recognize from the teachings herein, that the seal 405 may be placed in other portions of the case so that the forces downstream of the seal 405 result in a liner displacement which meets a pre-determined criteria. For instance and without limitation, the seal 405 may be placed between a first junction 430 between the case forward portion 375 and the case diverging portion 380 or a second junction 435 between the case diverging portion 380 and the case aft portion 385. The seal may also be placed in the case forward portion 375 and in the case aft portion 385.

Referring now to FIG. 5, in order to determine where to place the seal 405, one must: determine the inward load on the liner by multiplying the differences of pressure between the first gas path 318 and the second gas path 328 by the area of the liner along its path in registration with the case 340 (step 200); determine the outward load on the second segment 425 by its area along its length (step 210); and determine the net load on the system by subtracting the two determinations (step 220). If the remainder results in a liner displacement which meets the pre-determined criteria (step 230), place the seal 405 where the length of the second segment 425 ends adjacent the first segment 420 (step 240). If the remainder results in a liner displacement which does not meet the pre-determined criteria, the relative lengths of the first segment 420 and the second segment 425 are adjusted (step 250) until the remainder results in a liner displacement which meets the pre-determined criteria to minimize a signature of the engine 10 and the nozzle 300.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. Apparatus for minimizing signature of an engine having an exhaust gas path and a fan gas path, said apparatus comprising:
a casing,
a liner disposed within said casing, said exhaust gas path passing within said liner and said fan gas path passing between said liner and said casing, wherein said casing is disconnected into an upstream portion and a downstream portion, each portion in registration with said liner, such that there are minimum pressure imbalances caused by said exhaust gas path, said fan gas path and ambient on said downstream portion.

2. The apparatus of claim 1 further comprising:
a flexible seal disposed between said upstream portion and said downstream portion.

3. The apparatus of claim 1 wherein said casing and said liner comprise an exhaust nozzle.

4. The apparatus of claim 1 wherein said casing and said liner further comprise a forward portion and an aft portion wherein a flexible seal is disposed between said casing forward portion and said casing aft portion.

5. The apparatus of claim 4 wherein said casing and said liner further have a convergent portion disposed between said forward portion and said aft portion.

6. The apparatus of claim 5 wherein said flexible seal is disposed within said casing divergent portion.

7. The apparatus of claim 1 wherein there are no supports between said upstream segment and said downstream segment.

8. A nozzle for minimizing signature of a gas turbine engine having an exhaust gas path and a fan gas path, said nozzle comprising:
a casing,
a liner disposed within said casing, said exhaust gas path passing within said liner and said fan gas path passing between said liner and said casing, wherein said casing is disconnected into an upstream portion and a downstream portion, each portion in registration with said liner, such that there are minimum pressure imbalances caused by said exhaust gas path, said fan gas path and ambient on said downstream portion.

9. The apparatus of claim 8 further comprising:
a flexible seal disposed between said upstream portion and said downstream portion.

10. The apparatus of claim 8 wherein said casing and said liner further comprise a forward portion and an aft portion wherein a flexible seal is disposed between said casing forward portion and said casing aft portion.

11. The apparatus of claim 10 wherein said casing and said liner further have a convergent portion disposed between said forward portion and said aft portion.

12. The apparatus of claim 11 wherein said flexible seal is disposed within said casing divergent portion.

13. The apparatus of claim 12 wherein there are no supports upstream of said flexible seal between said casing and said liner.

14. The apparatus of claim 8 wherein there are no supports between said upstream segment and said downstream segment.

15. A method for designing a nozzle for minimizing signature of a gas turbine engine having an exhaust gas path and a fan gas path, said method comprising:
providing a casing,
providing a liner disposed within said casing, said exhaust gas path passing within said liner and said fan gas path passing between said liner and said casing, wherein said casing is disconnected into an upstream portion and a downstream portion, each portion in registration with said liner, such that there are minimum pressure imbalances caused by said exhaust gas path, said fan gas path and ambient on said downstream portion.

16. The method of claim 15 further comprising:
providing a flexible seal between said upstream portion and said downstream portion.

17. The method of claim 15 further comprising:
determining an inward load on said liner,
determining an outward load on said downstream portion, and
determining a net of said inward load and said outward load.

18. The method of claim 17 further comprising:
adjusting a length of said downstream portion if said net does not result in a liner displacement which meets a pre-determined criteria.

19. The method of claim 18 further comprising:
adjusting a length of said upstream portion if said net does not result in a liner displacement which meets a pre-determined criteria.
